(19) United States
(12) Patent Application Publication
(10) Pub. No.: US 2013/0338846 A1
(43) Pub. Date: Dec. 19, 2013

(54) Secure device for converting digital controls into analog power signals for aircraft

(71) Applicant: THALES, Neuilly-sur-Seine (FR)

(72) Inventors: Yannick MERET, Valence (FR); Damien BROCAS, Valence (FR)

(21) Appl. No.: 13/918,508

(22) Filed: Jun. 14, 2013

(30) Foreign Application Priority Data
Jun. 15, 2012 (FR) 12 01713

(51) Int. Cl. G06F 1/26

(52) U.S. Cl. CPC G06F 1/26
USPC 700/297

(57) ABSTRACT

A secure conversion device for an aircraft equipped with a digital computer and an analog actuator, said device being capable of converting discrete digital controls provided by the computer into analog power signals transmitted to the analog actuator and making it possible to steer said actuator, comprises a security module, making it possible to identify inconsistencies in the discrete digital controls and to interrupt the transmission of the analog power signals toward the analog actuator when an inconsistency in the discrete digital controls is identified. The device also comprises a detection module, making it possible to determine power levels of the analog power signals. The device also comprises a monitoring module, making it possible to detect anomalies in power supply levels of components of the device.

The present invention belongs to the field of security for devices for converting digital controls into analog power controls. More precisely, it relates to a secure conversion device for an aircraft capable of converting discrete digital controls transmitted by a computer into an analog power signal for driving an analog actuator of the aircraft.

Latest-generation aircraft are generally equipped with electrical flight controls driven by a digital computer. In particular, control surfaces and their trims are controlled by a digital computer, generally known as the avionics suite, by way of electrical flight controls transmitted to the actuators of these control surfaces and trims. For the duration of an aircraft model's commercial life it is possible to adapt the computer to adapt to changes in legislation or simply to improve the aircraft's flight performance. However, older-generation aircraft equipped with analog actuators driven by analog computers are more difficult to modernize. Replacing the existing flight controls by electrical flight controls, which would make it possible to employ a latest-generation digital computer, is often difficult and very expensive. This raises the problem of obsolescence in analog control computers. For control surface or trim autopilot systems, it is particularly desirable to adapt the existing analog actuators to suit latest-generation digital computers. These digital computers are not generally designed to be adapted to suit actuators requiring analog power control.

An interface compatibilizing latest-generation digital computers with older-generation analog actuators is therefore desirable. Flight control functions generally being critical, the coupling device must be able to ensure integrity of control in order to ensure a high level of security, in compliance with current regulatory requirements. Of course, the device must also have small dimensions and a low mass to be easily fitted onto existing aircraft. The general idea of the present invention consists in implementing a simple, non-programmable conversion device ensuring the secure conversion of standardized discrete controls originating in a digital computer into an analog power control suited to the analog actuators of the avionics suite to be modernized. This implementation makes it possible to isolate firstly a developing programmable assembly, the digital computer, and secondly a simple secure conversion device that is easily certifiable and suited to the specifics of the aircraft model under consideration. This type of conversion device is especially suited to the implementation of control surface or trim autopilot functions.

To this end, the object of the invention is a secure conversion device for an aircraft equipped with a digital computer and an analog actuator, said device being capable of converting discrete digital controls provided by the computer into analog power signals transmitted to the analog actuator and making it possible to steer said actuator. The device comprises a security module, making it possible to identify inconsistencies in the discrete digital controls and to interrupt the transmission of the analog power signals toward the analog actuator when an inconsistency in the discrete digital controls is identified.

The invention also relates to an aircraft comprising at least one computer, at least one analog actuator and a secure conversion device having the characteristics described previously, to convert discrete digital controls provided by the computer into analog power signals transmitted to the analog actuator.

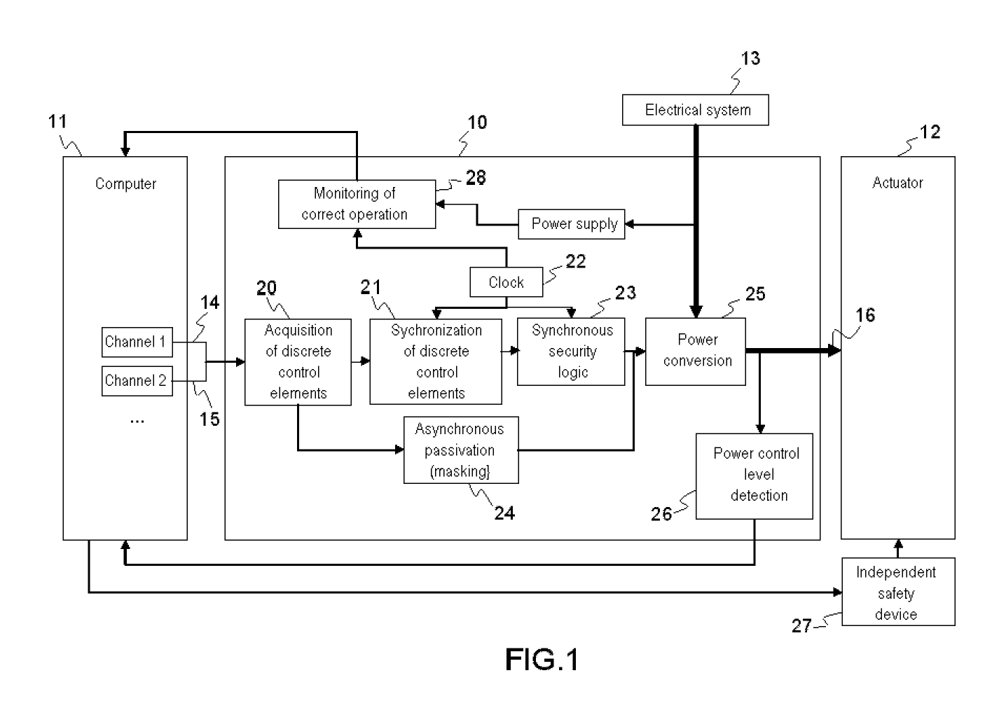

The invention will be better understood, and other advantages will appear, on reading the detailed description of a preferred embodiment of the invention described in FIG. 1.

FIG. 1 shows the functional architecture of a secure conversion device for an aircraft according to the invention. The secure conversion device 10 provides the interface between at least one digital computer 11 and at least one analog actuator 12. For example, this could be a trim actuator for a yaw, pitch or roll control surface, for which it would be desirable to add an autopilot mode that is not available in the first-generation analog actuator. The aircraft additionally comprises an on-board electrical system 13 which powers the conversion device 10 and allows the delivery of a power necessary for driving the analog actuator 12.

The digital computer 11 provides discrete digital controls 14 and 15, for example trim control commands, for the conversion device 10. These discrete digital controls 14 and 15 are converted into analog power signals 16 that are transmitted to the analog actuator 12.

The conversion device comprises a plurality of modules according to the architecture shown in FIG. 1. As previously indicated, the conversion device 10 is embodied using simple logic components and standard power components; it does not include a programmable component, which would be more complicated to implement and certify.

A first module 20 provides for the acquisition of the discrete digital controls 14 and 15, and transmits these controls to a second module 21 which carries out the synchronization of state changes for the controls on an internal clock 22.

The device 10 also comprises a module 23, known as the synchronous security module, which verifies the consistency of the synchronized controls transmitted by the synchronization module 21. The design of this module makes it possible to compare a plurality of digital controls, for example 14 and 15, to ensure the consistency of the request from the computer 11 toward the analog actuator 12. As an example for a trim actuator, the digital control 14 is a discrete control pulse to the right and the digital control 15 is a discrete control pulse to the left, so the module 23 ensures that there is no simultaneous transmission of the controls to the right and to the left.

In other words, the synchronous security module 23 makes it possible to identify inconsistencies between the discrete digital controls 14 and 15, synchronized using the internal clock 22 of the device 10. If an inconsistency is identified, the module 23 makes it possible to interrupt the transmission of the analog power signals 16 toward the analog actuator. In one possible embodiment of the invention, the actuator being a DC motor, the interruption of the transmission of the power signal causes the motor to stop.

The device 10 also comprises a module 24, known as the asynchronous security module, the role of which is to interrupt the power control toward the analog actuator 12 when all the digital controls coming from the computer 11 are inactive. This is known as asynchronous passivation, the interruption of a power control independently of the internal clock 22, a malfunction in which can lead to a fault in the synchronized digital controls described previously. Thus, the asynchronous security module 24 makes it possible to identify an inconsistency when all the discrete digital controls are inactive, and if need be to interrupt the transmission of the analog power signals 16 toward the analog actuator.

The synchronous security module 23 and asynchronous security module 24 together form a security module. This security module has the aim of blocking non-integral controls. In other words, the device 10 comprises a security module, making it possible to identify inconsistencies in the discrete digital controls 14 and 15 and to interrupt the transmission of the analog power signals 16 toward the analog actuator 12 when an inconsistency in the discrete digital controls 14 and 15 is identified.

The device 10 also comprises a conversion module 25 capable of converting the discrete digital controls 14 and 15 provided by the computer 12 into analog power signals 16 transmitted to the analog actuator 12 and making it possible to steer said actuator 12. By design, the conversion module 25 is suited to the analog actuator 12 which it has to steer. For example in the case where the actuator 12 is a DC motor, the conversion module comprises an H-bridge electronic structure, making it possible to control the electrical power supply transmitted to the motor. An H-bridge including a dead time for the changing of the control direction will advantageously be able to be implemented.

A detection module 26 comprises means for determining power levels of the analog power signals 16, and for transmitting these power levels to the computer 11. As shown in FIG. 1, this module provides the computer 11 with a re-reading of the power signals that is independent of the discrete digital controls. These power levels are transmitted to the computer 11 to establish an operational diagnostic for the device 10. Advantageously, the computer 11 comprises diagnostic means which make it possible to analyze these power levels with regard to the digital controls it has transmitted. When a malfunction is detected, the computer 11 can directly stop the analog actuator 12 by way of an independent safety device 27.

Finally, the device 10 comprises a monitoring module 28 comprising means for both monitoring power supply levels, internal and external, by the electrical system 13 and monitoring the regularity of the internal clock 22. Any possible anomalies are transmitted by the monitoring module 28 to the computer 11 to establish an operational diagnostic for the device. Thus, the monitoring module 28 comprises means for detecting anomalies in power supply levels for components of the device 10. Advantageously, it also makes it possible to detect an anomaly in the regularity of the internal clock 22. The diagnostic means of the computer 11 make it possible to analyze these anomalies and, if necessary, to stop the analog actuator 12 independently of the device 10 by way of the independent safety device 27.

The device 10 thus configured has three levels of safety, embodied by three independent modules: the security module 23 and 24, the detection module 26 and the monitoring module 28. This implementation of the secure conversion device 10 is particularly beneficial as it guarantees a high level of safety, by way of a simple, compact, inexpensive device made up of simple logic components and standard power components. This device makes it possible to use a latest-generation digital computer, having a powerful and certified drive system, on an older-generation aircraft, for driving analog actuators.

The invention also relates to an aircraft comprising at least one digital computer 11, at least one analog actuator 12 and a secure conversion device 10 having the characteristics described previously; the conversion device 10 making it possible to convert digital controls 14 and 15 provided by the computer 11 into analog power signals 16 transmitted to the analog actuator 12.

Advantageously, the digital computer 11 comprises a diagnostic module for the secure conversion device 10, based on the power levels of the analog power signals 16 transmitted by the detection module 26 of the conversion device 10, and on the anomalies transmitted by the monitoring module 28 of the conversion device 10. This diagnostic software module is specific to the analog actuator 12 and to the conversion device 10. If the computer's diagnostic module detects a malfunction in the conversion device 11, it can stop the actuator by way of the independent safety device 27.

The digital computer 11, the secure conversion device 10 and the independent safety device 27 thus configured form a fail/passive secure system. According to this terminology, well known to those skilled in the art, a security system of the fail/passive type makes it possible, when an error is detected, to interrupt the action of the system before the error has an effect. For example, in the case of an autopilot system on an aircraft, a fail/passive security system does not generate any action on the aircraft's control surfaces in the case of a failure, and the pilot resumes control of the aircraft when a failure is detected.

Advantageously, the analog actuator 12 is a trim actuator, and more particularly a yaw-axis trim actuator. The digital computer 11 comprises a yaw-axis autopilot system, incorporating simultaneous automatic driving of the actuator for the yaw control surface and of the yaw-axis trim actuator.

The implementation of a conversion device and an aircraft according to the invention is particularly advantageous as it does not require modification of the existing actuators. It makes it possible to add recent functionality, present on a latest-generation digital computer, to a previous-generation aircraft. The invention makes it possible to standardize the digital computer by isolating the hardware specifics in a separate component. Due to its design the component also presents the advantage of being of limited dimensions and mass; it is therefore easily adaptable to suit different types of aircraft. The power consumption of the signal part is relatively low and the cost of such a component is also relatively moderate. Most of all, certification is greatly facilitated by the design of a non-programmable component incorporating several levels of security. This invention is particularly suited to the control of a trim actuator, for example for regional transport aircraft.

1. A secure conversion device for an aircraft equipped with a digital computer and an analog actuator, said device being capable of converting discrete digital controls provided by the computer into analog power signals transmitted to the analog actuator and making it possible to drive said actuator, characterized in that the device comprises comprising a security module, making it possible to:
identify inconsistencies in the discrete digital controls, and
interrupt the transmission of the analog power signals toward the analog actuator when an inconsistency in the discrete digital controls is identified.

2. A secure conversion device according to claim 1, wherein the security module comprises:
a first synchronous security module, comprising means for identifying inconsistencies between the discrete digital controls, which are synchronized by way of an internal clock in the secure conversion device,
a second asynchronous security module, comprising means for identifying an inconsistency when all the discrete digital controls are inactive; the inconsistencies identified by each of the two modules, synchronous and asynchronous, causing the interruption of the transmission of the analog power signals toward the analog actuator.

3. A secure conversion device according to claim 1, further comprising a detection module, making it possible to determine power levels of the analog power signals; said power levels being transmitted to the computer to establish an operational diagnostic for the secure conversion device.

4. A secure conversion device according to claim 1, further comprising a monitoring module, making it possible to detect anomalies in power supply levels of components of the secure conversion device; said anomalies being transmitted to the computer to establish an operational diagnostic for the secure conversion device.

5. A secure conversion device according to claim 2, wherein the monitoring module comprises means for detecting an anomaly in the regularity of the internal clock.

6. An aircraft comprising at least one computer and at least one analog actuator, further comprising a secure conversion device according to claim 1, to convert discrete digital controls provided by the computer into analog power signals transmitted to the analog actuator.

7. An aircraft according to claim 6, wherein the secure conversion device further comprises a detection module, making it possible to determine power levels of the analog power signals, said power levels being transmitted to the computer to establish an operational diagnostic for the secure conversion device, the secure conversion device further comprising a monitoring module, making it possible to detect anomalies in power supply levels of components of the secure conversion device, said anomalies being transmitted to the computer to establish an operational diagnostic for the secure conversion device, and the computer further comprises a diagnostic module for the secure conversion device, based on the power levels of the analog power signals transmitted by the detection module of the secure conversion device, and on the anomalies transmitted by the monitoring module of the secure conversion device, making it possible to detect a malfunction in the secure conversion device.

8. An aircraft according to claim 7, wherein the computer stops the analog actuator by way of an independent safety device when it detects a malfunction in the secure conversion device.

9. An aircraft according to claim 6, in which the analog actuator is a trim actuator.

10. An aircraft according to claim 9, in which the computer houses an autopilot system for the trim actuator.
